(19) United States
(12) Patent Application Publication
(10) Pub. No.: US 2008/0129029 A1
(43) Pub. Date: Jun. 5, 2008

(54) Extensible equipment mast

(76) Inventor: Ardis L. Holte, Eugene, OR (US)

Correspondence Address: DAVID S ALAVI, 2852 WILLAMETTE ST, #402, EUGENE, OR, 97405-8200, US

(21) Appl. No.: 11/566,839

(22) Filed: Dec. 5, 2006

(51) Int. Cl. B60S 9/02

(52) U.S. Cl. 280/763.1

(57) ABSTRACT

An apparatus comprises: first and second elongated support members coupled for longitudinal movement; an attachment coupled to the second support member for longitudinal movement; proximal and distal idler wheel mounted rotatably on respective ends of the second support member; and first and second flexible, elongated linkages. Each linkage (i) is connected to the first support member, (ii) passes around and engages a corresponding idler wheel, and (iii) is connected to the attachment. The support members, the attachment, the idler wheels, and the linkages are arranged to provide concomitant (i) longitudinal movement of the second support member over a given distance in a given direction relative to the first support member and (ii) longitudinal movement of the attachment over about twice the given distance in the given direction relative to the first support member. The attachment can comprise, e.g., a drill head or other equipment.

### BACKGROUND

The field of the present invention relates to masts for raising or lowering equipment. In particular, a extensible equipment mast is described herein.

### SUMMARY

An apparatus comprises: (a) a first elongated support member; (b) a second elongated support member; (c) an attachment; (d) at least one proximal idler wheel; (e) at least one distal idler wheel; (f) a first flexible, elongated linkage; and (g) a second flexible, elongated linkage. The second elongated support member is coupled to the first support member so as to enable longitudinal movement of the second support member along the first support member. The attachment is coupled to the second support member so as to enable longitudinal movement of the attachment along the second support member. The at least one proximal idler wheel is mounted rotatably on a proximal end of the second support member; the at least one distal idler wheel mounted rotatably on a distal end of the second support member. The first flexible, elongated linkage (i) is connected to the first support member, (ii) passes around and engages the at least one proximal idler wheel, and (iii) is connected to the attachment. The second flexible, elongated linkage (i) is connected to the first support member, (ii) passes around and engages the at least one distal idler wheel, and (iii) is connected to the attachment. The support members, the attachment, the idler wheels, and the linkages are arranged to provide concomitant (i) longitudinal movement of the second support member over a given distance in a given direction relative to the first support member and (ii) longitudinal movement of the attachment over about twice the given distance in the given direction relative to the first support member. The attachment can comprise, e.g., a drill head or other equipment.

Objects and advantages pertaining to extensible equipment masts may become apparent upon referring to the exemplary embodiments illustrated in the drawings and disclosed in the following written description and/or claims.

### BRIEF DESCRIPTION OF THE DRAWINGS

FIGS. 1-3 illustrated schematically an extensible equipment mast at varying stages of extension.

FIGS. 4A-4C illustrate schematically a hydraulic cylinder and piston.

FIGS. 5A-5C illustrates schematically varying arrangements for idler wheels.

FIGS. 6A and 6B illustrate exemplary linkages and idler wheels.

The embodiments shown in the Figures are exemplary, and should not be construed as limiting the scope of the present disclosure and/or appended claims.

### DETAILED DESCRIPTION OF EMBODIMENTS

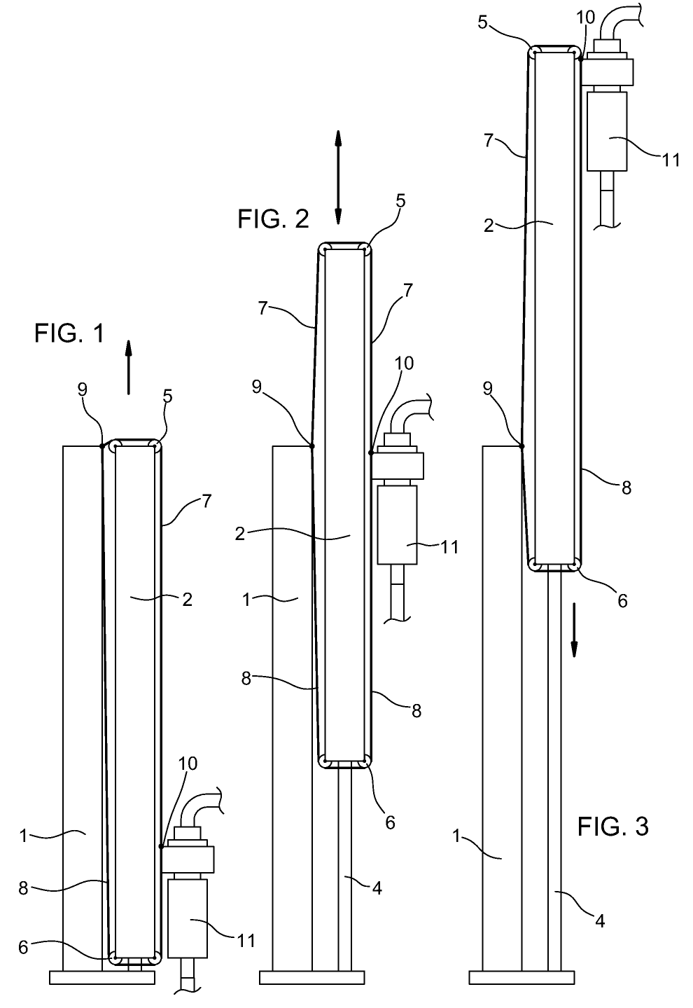

An exemplary embodiment of an extensible equipment mast is illustrated schematically in FIGS. 1-3 in various stages of extension. The equipment attachment 11 supported by the extensible mast is shown at its lowest position in FIG. 1, at its highest position in FIG. 3, and at an intermediate position in FIG. 2. The apparatus comprises: (a) a first elongated support member 1; (b) a second elongated support member 2; (c) the attachment 11; (d) at least one proximal idler wheel 6; (e) at least one distal idler wheel 5; (f) a first flexible, elongated linkage 8; and (g) a second flexible, elongated linkage 7. The second elongated support member 2 is coupled to the first support member 1 so as to enable longitudinal movement of the second support member 2 along the first support member 1 in both directions. The equipment attachment 11 (e.g., a rotating drill head) is coupled to the second support member 2 so as to enable longitudinal movement of the attachment 11 along the second support member 2. The proximal idler wheel 6 (two idler wheels 6 are shown in the exemplary embodiment) is mounted rotatably on a proximal end of the second support member 2. The distal idler wheel 5 (two idler wheels 5 are shown in the exemplary embodiment) is mounted rotatably on a distal end of the second support member 2.

The first flexible, elongated linkage 8 (i) is connected to the first support member 1 at an anchor point 10, (ii) passes around and engages the at least one proximal idler wheel 6, and (iii) is connected to the attachment 11 at the anchor point 10. The second flexible, elongated linkage 7 (i) is connected to the first support member 1 at the anchor point 10, (ii) passes around and engages the at least one distal idler wheel 5, and (iii) is connected to the attachment 11 at anchor point 10. The support members 1 and 2 can be coupled by rails, guides, bearings, gears, linkages 7 and 8 and idler wheels 5 and 6, or any other suitable mechanism or adaptation that enables relative longitudinal movement. Similarly, the support member 2 and attachment 11 can be coupled by rails, guides, bearings, gears, linkages 7 and 8 and idler wheels 5 and 6, or any other suitable mechanism or adaptation that enables relative longitudinal movement. Support members 1 and 2 can be arranged substantially parallel to one another, adjacent one another (i.e., side-by-side), in a telescoping arrangement (i.e., one inside the other), or in any other suitable mechanical arrangement. The support members 1 and 2, the attachment 11, the idler wheels 5 and 6, and the linkages 7 and 8 are arranged to provide concomitant (i) longitudinal movement of the second support member 2 over a given distance in a given direction relative to the first support member 1 and (ii) longitudinal movement of the attachment 11 over about twice the given distance in the given direction relative to the first support member 1.

In the exemplary embodiment of the Figures, each of the elongated support members 1 and 2 comprises a substantially vertical, elongated mast, and the equipment attachment 11 comprises a rotating drill head. In this example the proximal direction would be downward while the distal direction would be upward. In alternative embodiments falling within the scope of the present disclosure, the support members 1 and 2 can be positioned in any desired orientation, and equipment attachment 11 can comprise any piece of equipment or assembly desired to be moved along the support members 1 and 2.

The presence of the two linkages 7 and 8 enables coupling of the relative movements of the second support member 2 and the attachment 11 and application of force to the attachment 11 in both directions along support member 1. This is in contrast to the arrangement in a fork lift, for example, wherein force is applied only in the upward direction to produce coupled movement of a support member and the forks, with a linkage arranged to apply only upward force to move the support member and the forks. Downward motion of the forks of a forklift is gravity-assisted (and typically braked or otherwise controlled by application of upward force through the linkage). In the exemplary embodiment of FIGS. 1-3, the force applied to move support member 2 upward is partly transmitted through the upper linkage 7 to also move attachment 11 upward at twice the rate of movement of support member 2. Conversely, downward force can be applied to support member 2 and partly transmitted through the lower linkage 8 to also apply downward force to attachment 11. This downward application of force is unnecessary (and undesirable and in fact hazardous) in a fork lift, for example, but is desirable in other circumstances. For example, if the equipment attachment 11 is a rotating drill head, upward force is required to raise the drill head to a sufficient height to begin drilling or to withdraw a drill bit from a hole, but downward force is needed to drive the drill bit during the drilling phase.

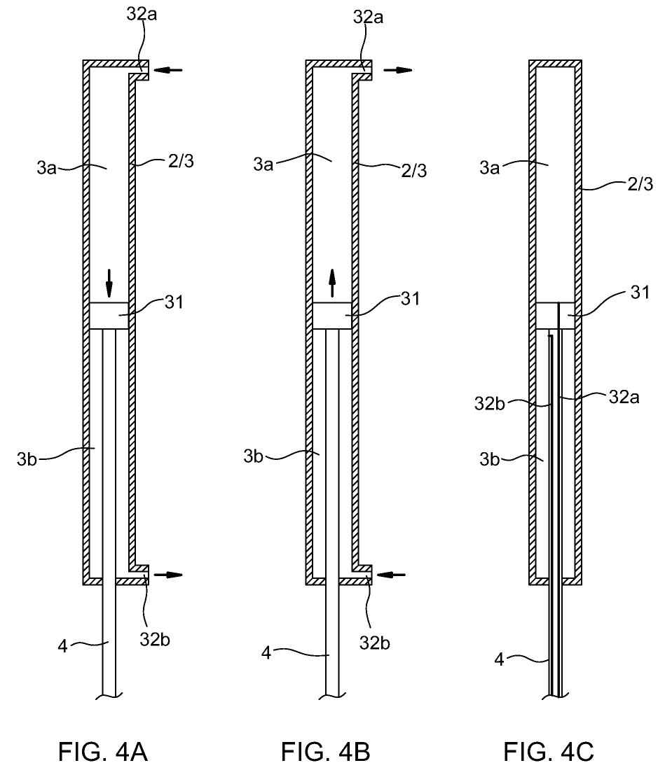

The extensible equipment mast can further comprise an actuator coupled to the second support member 2 to move it along the first support member 1. In the exemplary embodiment of FIGS. 1-3, the actuator comprises a hydraulic cylinder 3 within the second support member 2 and a hydraulic piston 31 within the hydraulic cylinder 3 and coupled to a piston rod 4. The piston 31 and cylinder 3 are shown in longitudinal section in FIGS. 4A-4C. The end of the piston rod 4 rests on a base that also supports the first support member 1, and passes into the bottom end of the hydraulic cylinder 3 through a seal of any suitable type and through the lower portion of the cylinder 3 to connect to the piston 31. The hydraulic piston 31 divides the hydraulic cylinder 3 into two chambers 3a and 3b each supplied by respective hydraulic lines 32a and 32b. The hydraulic lines 32a and 32b can be arranged in any suitable manner. In FIGS. 4A and 4B they are shown as connections to the cylinder 3 through its wall; in FIG. 4C they are shown passing upward through the piston rod 4 and communicating with the chambers 3a and 3b through the rod 4 or the piston 31. Any other suitable arrangement of the hydraulic lines shall fall within the scope of the present disclosure.

Introduction of high-pressure hydraulic fluid into chamber 3a through hydraulic line 32a and simultaneous release of hydraulic fluid from chamber 3b through hydraulic line 32b results in downward force on and downward movement of piston 31 relative to cylinder 3 and support member 2 (FIG. 4A). Since the lower end of piston rod 4 is supported by the base, downward movement of the piston 32 relative to cylinder 3 causes upward movement of support member 2. The arrangement of linkage 7 and idler wheels 5 causes concomitant upward movement of equipment attachment 11 at twice the rate of upward movement of the support member 2. Reversing the preceding procedure, introduction of high-pressure hydraulic fluid into chamber 3b through hydraulic line 32b and simultaneous release of hydraulic fluid from chamber 3a through hydraulic line 32a results in upward force on and upward movement of piston 31 relative to cylinder 3 and support member 2 (FIG. 4B). Since the lower end of piston rod 4 is supported by the base, upward movement of the piston 32 relative to cylinder 3 causes downward movement of support member 2. The arrangement of linkage 8 and idler wheels 6 causes concomitant downward movement of equipment attachment 11 at twice the rate of downward movement of the support member 2.

Any other suitable actuator can be employed within the scope of the present disclosure to effect movement of support member 2 relative to support member 1 and concomitant movement of the equipment attachment 11 relative to support member 1 at twice the rate movement of the support member 2, including but not limited to mechanical, hydraulic, pneumatic, or other suitable actuators. In one example, a rack and pinion mechanism and a motor can be employed to effect relative movement of support members 1 and 2. In another example, a motor can be arranged to drive one or both idler wheels 5 and 7 thereby applying tension to one or both of the elongated linkages 6 and 8 and effecting movement of the second support member 2 and the attachment 11.

Instead of arranging the actuator to apply force to effect movement of the support member 2 relative to support member 1, it may be desirable in some circumstance to arrange the actuator to apply force to effect relative motion of the equipment attachment 11 and support member 2. In this alternative arrangement, as in the arrangement shown in the Figures, the arrangement of the linkages 7 and 8 and the idler wheels 5 and 6 will result in concomitant movement of: the support member 2 relative to the support member 1, and the attachment 11 relative to the support member 2 at twice the rate. In the alternative arrangement, any suitable actuator can be employed to apply force to effect movement of the attachment 11 relative to the support member 2.

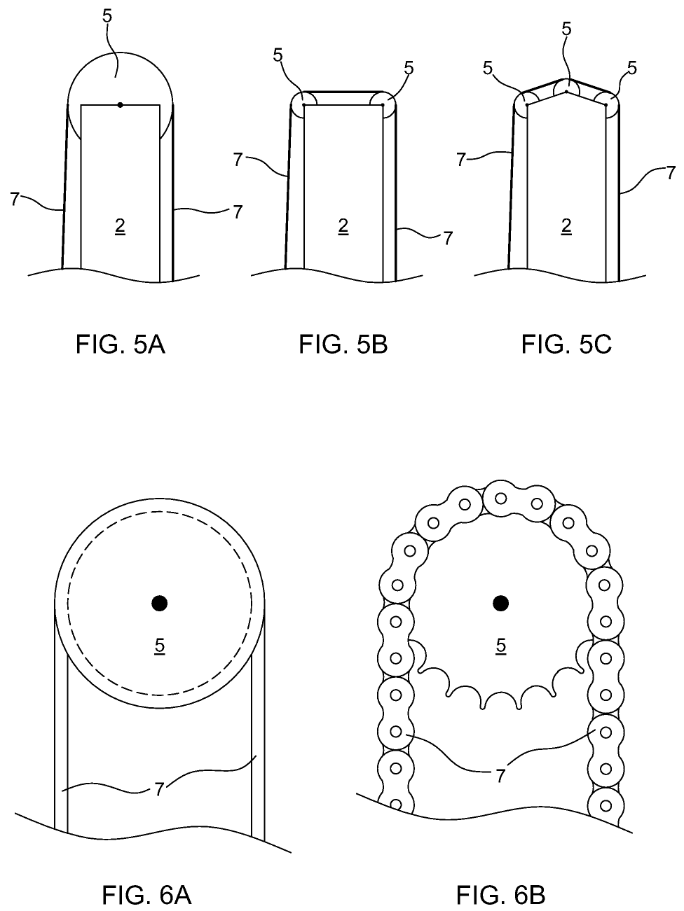

The number and arrangement of the idler wheels 5 and 6 can vary as needed or desired within the scope of the present disclosure. Several arrangements are illustrated schematically in FIGS. 5A-5C for idler wheel(s) 5 mounted rotatably at the distal end of support member 2. Similar arrangements can be employed for idler wheel(s) 6 mounted rotatably at the proximal end of support member 2. In FIG. 5A, the linkage 7 passes around a single idler wheel 5 mounted rotatably at the distal end of support member 2. In FIG. 5B, the linkage 7 passes around a pair of idler wheels 5 mounted rotatably at the distal end of support member 2. In FIG. 5C, the linkage 7 passes around three idler wheels 5 mounted rotatably at the distal end of support member 2. Other suitable numbers or arrangements of idler wheels 5 or 6 can be employed within the scope of the present disclosure.

Each flexible, elongated linkage 7 and 8 can comprise any suitable linkage. In one example, each of the linkages 7 and 8 comprises at least one cable linkage, and the corresponding idler wheels 5 and 6 comprise pulley wheels engaged with the cable linkages (illustrated schematically for idler wheel 5 in FIG. 6A). In another example, each of linkages 7 and 8 comprises a chain linkage, and the corresponding idler wheels 5 and 6 comprise gear wheels engaged with at least one of the chain linkages (illustrated schematically for idler wheel 5 in FIG. 6B).

In one exemplary embodiment, the first and second linkages 7 and 8 can together comprise at single, continuous, closed linkage connected at a first segment thereof to the anchor point 9 on the support member 1 and at a second segment thereof to the anchor point 10 on the equipment attachment 11. In another exemplary embodiment, each of the linkages 7 and 8 can comprise a separate linkage. In some exemplary embodiments, the first and second linkages 7 and 8 are each connected to the support member 1 at a common location at anchor point 9 (or equivalently, a single closed linkage is connected at a single point thereof to anchor point 9). In other embodiments the linkages 7 and 8 can be connected to support member 1 at separate anchor points (or equivalently, a single closed linkage can be connected to support member 1 along a substantial length thereof). Likewise, the connection of the linkages 7 and 8 to the equipment attachment can be at a single anchor point 10, or can be at separate anchor points. The specific arrangements of the anchor points and corresponding lengths of the linkages 7 and 8 determines in part the range of movement of the support member 2 and the equipment assembly 11 relative to the support member 1.

An extensible equipment mast can be made a method comprising: (a) coupling to the first elongated support member 1 the second elongated support member 2; (b) coupling to the second support member 2 the equipment attachment 11; (c) mounting rotatably at least one proximal idler wheel 6 on the proximal end of the second support member 2; (d) mounting rotatably at least one distal idler wheel 5 on the distal end of the second support member 2; (e) connecting a first flexible, elongated linkage to the first support member, passing the first linkage around and engaging it with the at least one proximal idler wheel, and connecting the first linkage to the attachment; (f) connecting a second flexible, elongated linkage to the first support member, passing the second linkage over the at least one distal idler wheel, and connecting the second linkage to the attachment; and (g) arranging the support members, the attachment, the idler wheels, and the linkages to provide concomitant (i) longitudinal movement of the second support member over a given distance in a given direction relative to the first support member and (ii) longitudinal movement of the attachment over about twice the given distance in the given direction relative to the first support member.

It is intended that equivalents of the disclosed exemplary embodiments and methods shall fall within the scope of the present disclosure and/or appended claims. It is intended that the disclosed exemplary embodiments and methods, and equivalents thereof, may be modified while remaining within the scope of the present disclosure or appended claims.

For purposes of the present disclosure and appended claims, the conjunction “or” is to be construed inclusively (e.g., “a dog or a cat” would be interpreted as “a dog, or a cat, or both”; e.g., “a dog, a cat, or a mouse” would be interpreted as “a dog, or a cat, or a mouse, or any two, or all three”), unless: (i) it is explicitly stated otherwise, e.g., by use of “either . . . or”, “only one of . . . ”, or similar language; or (ii) two or more of the listed alternatives are mutually exclusive within the particular context, in which case “or” would encompass only those combinations involving non-mutually-exclusive alternatives. For purposes of the present disclosure or appended claims, the words “comprising”, “including”, and “having” shall be construed as open ended terminology, with the same meaning as if the phrase “at least” were appended after each instance thereof.

What is claimed is:

1. An apparatus comprising:
(a) a first elongated support member;
(b) a second elongated support member coupled to the first support member so as to enable longitudinal movement of the second support member along the first support member in both directions;
(c) an attachment coupled to the second support member so as to enable longitudinal movement of the attachment along the second support member;
(d) at least one proximal idler wheel mounted rotatably on a proximal end of the second support member;
(e) at least one distal idler wheel mounted rotatably on a distal end of the second support member;
(f) a first flexible, elongated linkage (i) connected to the first support member, (ii) passing around and engaging the at least one proximal idler wheel, and (iii) connected to the attachment; and
(g) a second flexible, elongated linkage (i) connected to the first support member, (ii) passing around and engaging the at least one distal idler wheel, and (iii) connected to the attachment,
wherein the support members, the attachment, the idler wheels, and the linkages are arranged to provide concomitant (i) longitudinal movement of the second support member over a given distance in a given direction relative to the first support member and (ii) longitudinal movement of the attachment over about twice the given distance in the given direction relative to the first support member.

2. The apparatus of claim 1 wherein the first and second support members are positioned adjacent one another.

3. The apparatus of claim 1 wherein the first and second support members are coupled in a telescoping arrangement.

4. The apparatus of claim 1 wherein each elongated support member comprises a substantially vertical, elongated mast.

5. The apparatus of claim 4 further comprising a hydraulic piston and cylinder arranged to raise or lower the second support member and thereby also raise or lower the attachment by about twice a distance by which the second support member is raised or lowered.

6. The apparatus of claim 4 wherein the attachment comprises a drill head.

7. The apparatus of claim 1 further comprising an actuator coupled to the second support member to move it along the first support member.

8. The apparatus of claim 7 wherein the actuator comprises a hydraulic piston and cylinder.

9. The apparatus of claim 1 further comprising an actuator coupled to the attachment to move it along the second support member.

10. The apparatus of claim 1 wherein each flexible, elongated linkage comprises at least one cable linkage and each idler wheel comprises a pulley wheel engaged with at least one of the cable linkages.

11. The apparatus of claim 1 wherein each flexible, elongated linkage comprises a chain linkage and each idler wheel comprises a gear wheel engaged with at least one of the chain linkages.

12. The apparatus of claim 1 wherein the first and second linkages together comprise at single, continuous, closed linkage connected at a first segment thereof to the first support member and at a second segment thereof to the attachment.

13. The apparatus of claim 1 wherein:
the first and second linkages are each connected to the first support member at a common location thereon; or
the first and second linkages are each connected to the attachment at a common location thereon.

14. The apparatus of claim 1 wherein:
at least two proximal idler wheels are mounted rotatably on the proximal end of the second support member and the first linkage passes around and engages the at least two proximal idler wheels; or
at least two distal idler wheels are mounted rotatably on the distal end of the second support member and the second linkage passes around and engages the at least two distal idler wheels.

15. An method comprising:
(a) coupling to a first elongated support member a second elongated support member so as to enable longitudinal movement of the second support member along the first support member;
(b) coupling to the second support member an attachment so as to enable longitudinal movement of the attachment along the second support member;
(c) mounting rotatably at least one proximal idler wheel on a proximal end of the second support member;
(d) mounting rotatably at least one distal idler wheel on a distal end of the second support member;
(e) connecting a first flexible, elongated linkage to the first support member, passing the first linkage around and engaging it with the at least one proximal idler wheel, and connecting the first linkage to the attachment;
(f) connecting a second flexible, elongated linkage to the first support member, passing the second linkage over the at least one distal idler wheel, and connecting the second linkage to the attachment; and
(g) arranging the support members, the attachment, the idler wheels, and the linkages to provide concomitant (i) longitudinal movement of the second support member over a given distance in a given direction relative to the first support member and (ii) longitudinal movement of the attachment over about twice the given distance in the given direction relative to the first support member.

16. The method of claim 15 wherein the first and second support members are positioned adjacent one another.

17. The method of claim 15 wherein the first and second support members are coupled in a telescoping arrangement.

18. The method of claim 15 wherein each elongated support member comprises a substantially vertical, elongated mast.

19. The method of claim 18 further comprising arranging a hydraulic piston and cylinder to raise or lower the second support member and thereby also raise or lower the attachment by about twice a distance by which the second support member is raised or lowered.

20. The method of claim 18 wherein the attachment comprises a drill head.

21. The method of claim 15 further comprising coupling an actuator to the second support member to move it along the first support member.

22. The method of claim 21 wherein the actuator comprises a hydraulic piston and cylinder.

23. The method of claim 15 further comprising coupling an actuator to the attachment to move it along the second support member.

24. The method of claim 15 wherein each flexible, elongated linkage comprises at least one cable linkage and each idler wheel comprises a pulley wheel engaged with at least one of the cable linkages.

25. The method of claim 15 wherein each flexible, elongated linkage comprises a chain linkage and each idler wheel comprises a gear wheel engaged with at least one of the chain linkages.

26. The method of claim 15 wherein the first and second linkages together comprise at single, continuous, closed linkage connected at a first segment thereof to the first support member and at a second segment thereof to the attachment.

27. The method of claim 15 wherein:
the first and second linkages are each connected to the first support member at a common location thereon; or
the first and second linkages are each connected to the attachment at a common location thereon.

28. The method of claim 15 wherein:
at least two proximal idler wheels are mounted rotatably on the proximal end of the second support member and the first linkage passes around and engages the at least two proximal idler wheels; or
at least two distal idler wheels are mounted rotatably on the distal end of the second support member and the second linkage passes around and engages the at least two distal idler wheels.
